(19) United States
(12) Patent Application Publication
(10) Pub. No.: US 2019/0276673 A1
(43) Pub. Date: Sep. 12, 2019

(54) METHOD OF MAKING AND SYNTHESIZING DIELECTRIC NANOFLUIDS

(71) Applicants: Eleftheria PYRGIOTI, Patra (GR); Aristides BAKANDRITSOS, Athens (GR); Georgios PEPPAS, Attikh (GR); UNIVERSTY OF PATRAS, Rio Patras (GR)

(72) Inventors: Eleftheria PYRGIOTI, Patra (GR); Aristides BAKANDRITSOS, Athens (GR); Georgios PEPPAS, Attikh (GR)

(73) Assignee: University of Patras, Rio Patras (GR)

(21) Appl. No.: 16/319,397

(22) PCT Filed: Jul. 12, 2017
(86) PCT No.: PCT/GR2017/000040

§ 371 Date: Jan. 21, 2019

(30) Foreign Application Priority Data
Jul. 24, 2016 (GR) 20160100388

(51) Int. Cl. C09C 1/24; C01G 49/08; H01B 3/20; H01F 27/10

(52) U.S. Cl. CPC C09C 1/24; C01G 49/08; H01B 3/20; B82Y 40/00; C01P 2004/64; C01P 2006/40; H01F 27/105

(57) ABSTRACT

A method of making and synthesizing dielectric nanofluids with hybrid colloidal iron oxide nanoparticles coated with oleic acid and by usage of natural ester oil matrix instead of mineral oil. The final product of dielectric nanofluid has enhanced dielectric and thermal properties without agglomeration and precipitation of the nanoparticles. The final product is intended to be used as dielectric insulation and cooling media for high voltage equipment/applications and/or other applications.

### CROSS REFERENCE TO RELATED APPLICATION

This application is a national stage entry of PCT/gr2017/000040 filed Jul. 12, 2017, under the International Convention claiming priority over Greece Patent Application No. 20160100388 filed Jul. 24, 2016.

### FIELD OF THE INVENTION

This patent is referring to a method of making and synthesizing dielectric nanofluids with hybrid iron oxide nanoparticles coated with oleic acid. The latter were appropriately added into the natural ester oil matrix (instead of mineral oil) as described below. The final product (nanofluid) demonstrated improved dielectric and thermal properties with complete absence of agglomeration or residue of the nanoparticles.

### BACKGROUND OF THE INVENTION

The power transformers are a vital and high cost parts of the power transmission network. They are intended to increase the voltage of the power generators to high voltage levels (i.e 110 kV-1000 kV), the end of the power transmission line is connected again on a power transformer in order to reduce the voltage level for the distribution power system. Based on the abovementioned function the power transformers are managing the energy transmitted via the power network in a way of minimum power losses due to the high voltage levels. The performance of the electrical insulation of the transformer is of high importance since during a potential failure of the insulation, the transformer may be destroyed and/or be degraded. The latter failure of electrical insulation of the transformer, translates into loss of power and electricity, high cost of power transformer replacement and a high risk of environmental pollution (due to the oil spreading on the soil).

Some techniques have been introduced for dielectric liquids concerning their cooling capability and/or dielectric insulation improvement.

Patent number EP1019336A1 is introducing colloid fluids with better dielectric and cooling performance while the patent US20110232940 is theoretically studying the nanofluids regarding the dielectric performance.

### SUMMARY OF THE INVENTION

The proposed patent is referring in a procedure of dielectric nanofluid synthesis with hybrid colloidal iron oxide-based nanoparticles, coated with oleic acid using natural ester oil instead of mineral oil.

The final dielectric nanofluid has enhanced dielectric and thermal properties by means of increased dielectric strength and increased thermal conductivity, while it is free of agglomeration and residue of the nanoparticles. The final product called coINF in this patent, is intended to be used us a dielectric insulating material, as a coolant for high voltage applications (transformers, switches, capacitors, batteries) and/or other applications wherein dielectric liquids can be used.

For specific concentration (0.012% w/v) it demonstrated increased dielectric strength and 45% better thermal response compared to the natural ester oil matrix. Furthermore, it maintained the aforementioned improved properties even after 200 continuous breakdown events, while the conventional dielectric liquids (natural ester oil, mineral) are degraded.

The suggested procedure of synthesis of the nanoparticles with their surfaces coated with oleic acid, results to a homogeneous dispersion of the nanoparticles and absence of agglomeration and residue.

The synthetic procedure of the dielectric nanofluid is consisted on the following steps:
3.62 gr (4 mmol) iron oleate—(C18H33O2)3Fe and 3.4 gr (12 mmol) oleic acid—C17H33COOH are diluted into 30 g of 1-octadecane—C18H36, purity 95% at 20° C.

The mixture was stirred (800 rpm) at room temperature for 1 h and then heated to 100° C. for 30 min under stirring (350 rpm) and then further heated to reflux at 318° C. for 1 h with 6.7° C./min γIα 1 h.

Consequently, the mixture is cooled at room and 8 ml of DCM (dichloromethane—CH2Cl2) is added under continuous stirring. Acetone—C3H60 is added followed by centrifugation. The procedure is repeater several times until the purity level reaches 20% per weight in oleic acid, while the rest 80% are iron oxides. The final concentration of the colloidal iron oxide nanoparticles (coIMIONs) in the mixture is 0.55% w/v.

The coIMIONs are added into the natural ester oil matrix at different concentrations (0.04%-0.012% w/v). The natural ester oil is a vegetable oil of wt %: vegetable oil >98.5%, Antioxidant additive <1.0%, Cold flow additive <1.0%, Colorant <1.0%

The dielectric nanofluid (coINF) which is produced from the proposed production process is compared with a conventional nanofluid with industrial purchased nanoparticles (in powder form) called pNF. The latter (pNF) nanofluid is assembled with conventional techniques, while the comparative results are demonstrated in FIGS. 1-5 and images 1A, 1B and in Table 1.

### BRIEF DESCRIPTION OF THE DRAWINGS

FIG. 1 shows a dynamic light scattering results (correlograms) form the two nanofluids. Inset: derived count rates of the two nanofluids. (n=3);

FIG. 2 shows a size distribution diagram of the colloidal MIONs synthesized from the thermolytic route;

FIG. 3 shows DLS of the pNF is depicted with red for the nanofluid as was synthesized, while with the green line after 100 electrical breakdown events. As depicted the mean diameter is considerably increased (from 150 nm to 350 nm); which is correlated with the agglomeration that took place;

FIG. 4 A shows the endurance tests for both samples, with 200 continuous AC high voltage breakdown events, are depicted. Outstanding stability of BDV performance is recorded for the case of coINF, which was maintained even after several months of storage;

FIG. 4B shows pNF demonstrated degradation of its performance after around 120 breakdown events. Such ultrastable behavior is reported for first time, and is probably associated with the discharge mechanism during the external field stress;

FIG. 5 shows a thermal response of the colloidal MIONs nanofluid and pure natural ester oil (matrix). The heating and cooling response is depicted for all the investigated concentrations; and

FIG. 6 shows an apparent charge of PD events versus the applied voltage for the case of insulating paper impregnated in coINF.

### DETAILED DESCRIPTION OF THE INVENTION

The dielectric nanofluid coINF contains hybrid colloidal nanoparticles (coIMIONs or coINP) while the nanofluid pNF contains commercially purchased nanoparticles (pMIONs or pNP).

For the synthesis of the nanofluid pNF iron oxide nanoparticles Fe3O4 were used with <50 nm diameter. Oleic acid with 99% purity was used and ethanol with purity of 98%. The synthesis procedure is described in 3 steps.

20 g of commercial MIONs (<50 nm) were added in 200 mL of ethanol and the mixture was heated at 60° C. in a water bath. Following, 0.28 mL of oleic acid was added and the mixture was mechanically agitated for 20 minutes. Afterwards, the mixture was mounted in an ultrasonic bath for 2 h, and then placed in 10 mL vials and centrifuged at 3000 rpm.

The precipitated oleic acid-coated nanoparticles were dried at 40° C. for 20 hours, grinded and the final surface modified MIONs were added to natural ester oil and sonicated for 30 min. The main molecular component of natural ester oil (Fr3) is the triglyceride-fatty acid ester, which contains a mixture of saturated and unsaturated fatty acids with chain length up to 22 carbon atoms, containing 1 to 3 double bonds.

Six different concentrations were prepared from 0.004% to 0.014% w/w with 0.002% step.

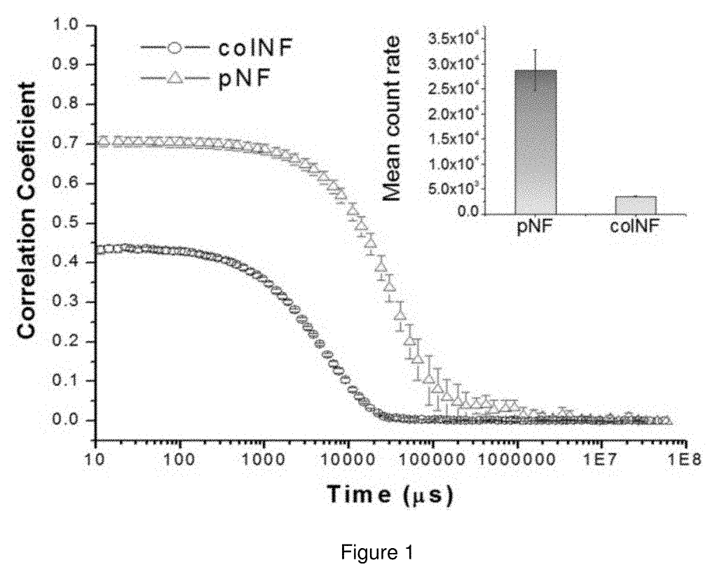

Evaluation of the aggregation extent of the nanoparticles in the oil phase was performed with light scattering. Scattered light was collected at a fixed angle of 173° from a Dynamic Light Scattering (DLS) apparatus, for 60 seconds at fixed attenuator and measurement position values. Correllograms and derived count rates reported were derived from these measurements. The correlogram from coINF displays a much faster decay than the respective response from pNF, as shown in FIG. 1. This manifests the significantly smaller size of the particles in the coINF system. DLS measurements also unveil the differences between the two samples, as far as the dispersion state of the MIONs is concerened. Both samples were measured at the concentration of 0.008% wt

FIG. 1: Dynamic light scattering results (correlograms) form the two nanofluids. Inset: derived count rates of the two nanofluids. (n=3).

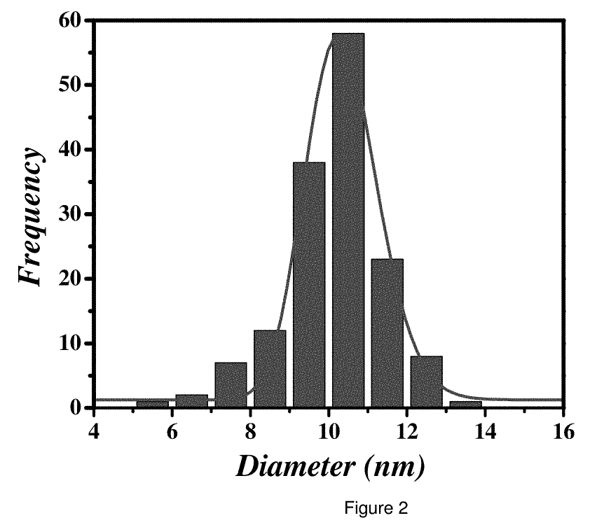

In FIG. 2 the distribution of the diameter of the coIMIONs is depicted as acquired from a Transmission Electron Microscopy (TEM)

In Image 1 digital images of the two products suspended in the vegetable oil (coINF and pNF) are shown one week after their preparation. The dramatic difference regarding the stability of the dispersed MIONs in the oil matrix is evident. The NF prepared with the commercial MIONs powder (pNF, Image 1b) demonstrated significant sedimentation after a short time period (1 week to one month depending on the concentration), losing its enhanced properties (vide infra). On the contrary, the NF prepared with the colloidal MIONs (coINF, Image 1a) exhibited zero sedimentation (for a period of at least 16 months) and dramatic enhancement of colloidal stability.

FIG. 2: Size distribution diagram of the colloidal MIONs synthesized from the thermolytic route.

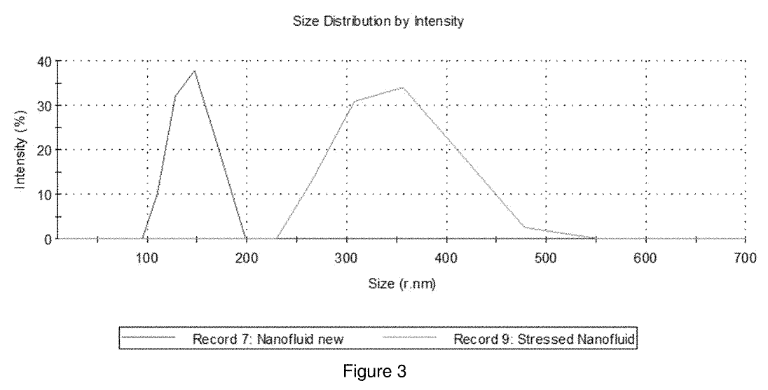

In FIG. 3 DLS of the pNF is depicted with red for the nanofluid as was synthesized, while with the green line after 100 electrical breakdown events. As depicted the mean diameter is considerably increased (from 150 nm to 350 nm); which is correlated with the agglomeration that took place.

FIG. 3: Distribution of the diameter for the pNF before (red) and after 100 breakdown events (green).

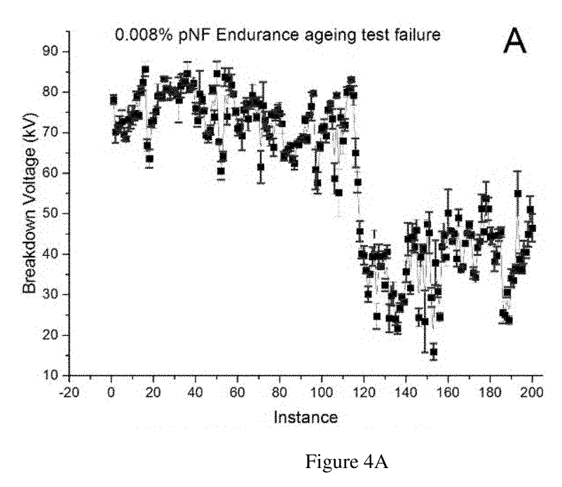

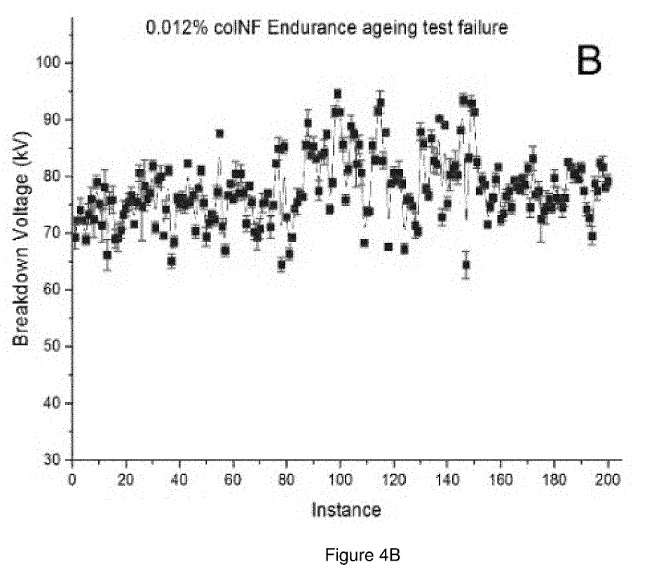

In FIG. 4 A,B the endurance tests for both samples, with 200 continuous AC high voltage breakdown events, are depicted. Outstanding stability of BDV performance is recorded for the case of coINF, which was maintained even after several months of storage. On the other hand, pNF demonstrated degradation of its performance after around 120 breakdown events. Such ultrastable behavior is reported for first time, and is probably associated with the discharge mechanism during the external field stress.

FIG. 4: Distribution of the AC breakdown voltage for a) pNF and for b) coINF, during endurance tests.

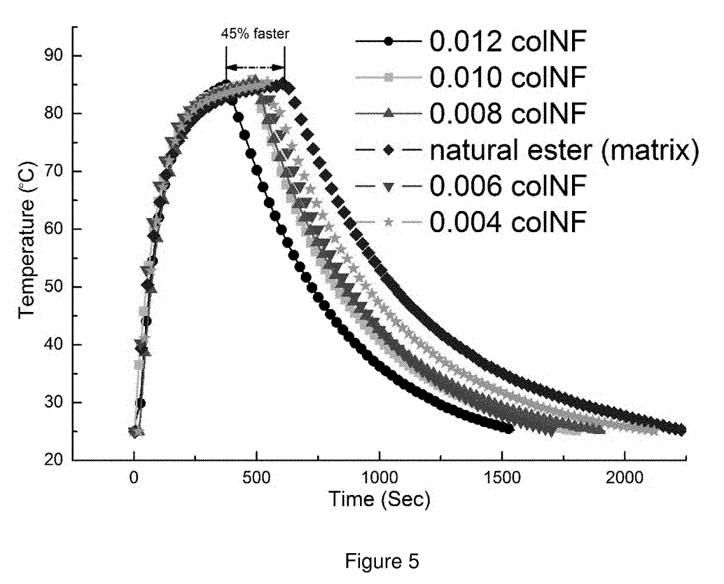

According to the results depicted in FIG. 5, the heat transfer enhancement is clear upon increasing the MIONs concentration. At the 0.012% w/w concentration, 45% enhancement in the thermal conductivity is observed, both during heating and cooling. The thermal response was continuously improved after the addition of nanoparticles. However, in higher than 0.012% w/v concentration for the coINF the dielectric properties were decreased.

FIG. 5: Thermal response of the colloidal MIONs nanofluid and pure natural ester oil (matrix). The heating and cooling response is depicted for all the investigated concentrations.

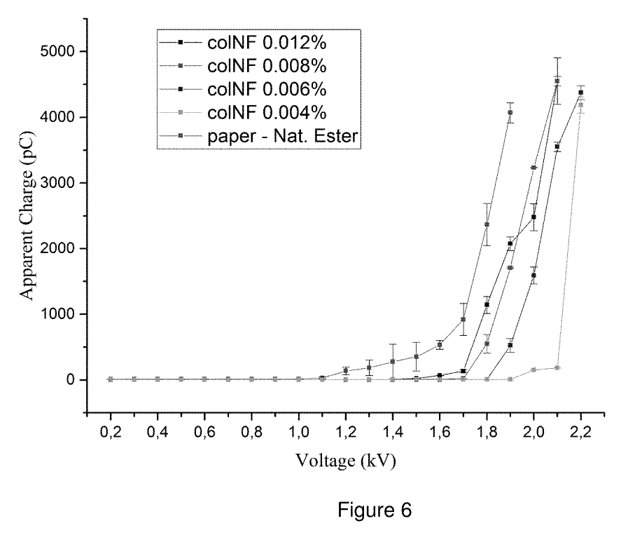

In FIG. 6 the apparent charge of PD events for the insulating paper (Nomex type) impregnated in coINF is depicted, in dependence to the applied voltage stress. Contrary to the previous case the apparent charge is always lower in comparison to the apparent charge of PD for the paper impregnated to natural ester. However, the apparent charge in increased with the increase of nanoparticle concentration and the inception voltage of PD is reduced.

FIG. 6: Apparent charge of PD events versus the applied voltage for the case of insulating paper impregnated in coINF.

The coINF demonstrated increased dielectric strength under high AC voltage Table 1: Mean breakdown voltage—BDV.) with increased breakdown voltage in comparison to that of pNF nanofluid and the natural ester oil.

TABLE 1
Mean breakdown voltage - BDV.

| Dielectric liquid | Mean BDV (kV) |
|---|---|
| coINF (0.012%) | 77.8 ± 6.7 |
| pNF (0.008%) | 77.7 ± 17.1 |
| Mineral oil | 70.3 ± 16.7 |
| Natural ester oil | 64.5 ± 12.6 |

The nanofluid coINF solves fundamental problems of the high voltage equipment such as:

Increased breakdown voltage, which is a fundamental property of nanofluids and vital in transformers and insulators industry by decreasing their size and weight

Increased thermal conductivity and response, which improves the cooling performance of the dielectric liquids in high voltage insulation applications (power transformers).

Decreased dielectric losses, which limits the problem of ageing of the paper-oil insulating solutions.

Decreased partial discharge phenomena of impregnated paper-oil insulations. The latter decrease the probability of potential discharge phenomena and limit the ageing of the transformer's insulation.

Minimized agglomeration, which makes the coINF a perfect replacement as a dielectric insulation media.

1. (canceled)

2. A method for production of dielectric nanofluids with hybrid colloidal nanoparticles of iron oxide with oleic acid coating and natural ester oil matrix, the method comprising the steps of:
diluting iron oleate and the oleic acid into 1-octadecane having a purity of 95% at room temperature (20° C.) to form a mixture;
agitating the mixture at 800 rpm at room temperature for 1 hour;
heating the mixture while stirring under 100° C., with 20° C. increase rate for 30 min at 350 rpm;
heating the mixture at 318° C. with temperature increase rate of 6.7° C./min for 1h;
cooling at room temperature;
adding dichloromethane under continuous stirring;
adding acetone;
centrifuging the mixture;
repeating the previous steps until reaching a purity level of 20% w/w for the oleic acid and 80% for the iron oxide nanoparticles to obtain hybrid colloidal nanoparticles;
adding the hybrid colloidal nanoparticles into the natural ester oil matrix.

3. The method of claim 2, wherein the mixture includes 3.62 gr of iron oleate and 3.4 gr of oleic acid, and 30 g of 1-octadecane.

4. The method of claim 2, wherein the hybrid colloidal nanoparticles have a final concentration of 0.55% w/v.
